(19) United States
(12) Patent Application Publication
(10) Pub. No.: US 2010/0318910 A1
(43) Pub. Date: Dec. 16, 2010

(54) WEB PAGE SEARCHING SYSTEM AND METHOD

(75) Inventor: PO-YU LU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/760,558

(22) Filed: Apr. 15, 2010

(30) Foreign Application Priority Data
Jun. 11, 2009 (CN) 200910303172.5

(51) Int. Cl. G06F 3/16; G06F 17/30

(52) U.S. Cl. 715/716; 707/758; 707/E17.108

(57) ABSTRACT

A web page searching method for searching web page with audio information includes assigning an identifiable label for each of created web pages; obtaining the label of the web page with audio information in response to a search operation; and indicating the web page to a user corresponding to the obtained label.

### BACKGROUND

1. Technical Field

The disclosure relates to a web page searching system, and more particularly to a web page searching system for searching web page with audio information and a method thereof.

2. Description of Related Art

The Internet has become an important way for people to obtain information. In general, users use a web browser installed on electronic devices to access the Internet, for example, the IE (Internet Explorer) browser. Users can use the IE browser to access web pages containing multimedia information. However, when the user wants to find the web page with audio information, he or she needs to check the web pages one by one to locate the audio information. It is complicated and inconvenient.

Therefore, it is necessary to provide a web page searching system for searching website with audio information more easily.

### BRIEF DESCRIPTION OF THE DRAWINGS

The components in the drawing are not necessarily drawn to scale, the emphasis instead being placed upon clearly illustrating the principles of the web page searching system.

FIG. 1 is a block diagram showing a hardware infrastructure of a web page searching system in an exemplary embodiment of the present disclosure.

FIG. 2 is a flowchart implementing the web page searching system in a first embodiment of the present disclosure.

FIG. 3 is a flowchart implementing the web page searching system in a second embodiment of the present disclosure.

### DETAILED DESCRIPTION

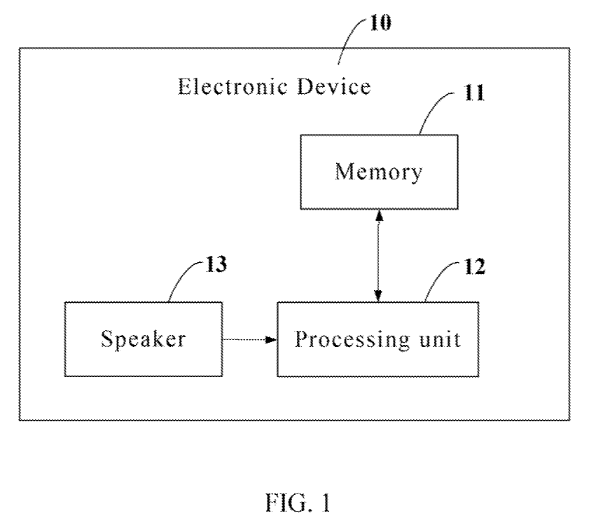

FIG. 1 is a block diagram showing a hardware infrastructure of an electronic device 10 with a web page searching system in an exemplary embodiment of the present disclosure. The web page searching system is stored in a memory 11 of the electronic device 10 in a form of program codes. When the electronic device 10 is activated, the program codes are executed by a processing unit 12 of the electronic device 10 to implement the web page searching system. The electronic device 10 may be touch-screen phones, personal digital assistants (PDA), computers, mobile phones etc. After the program codes are executed, the electronic device 10 can indicate a window of a web page with audio information in a noticeable manner to users. The noticeable manner may include highlighting a bar of the window of the web page with audio information, or outputting audio information by a speaker 13 of the electronic device 10 which can be identified corresponding to a relative position between bar of window of the web page with audio information and the bar of the window of the web page currently being used by the user when only one web page with audio information is created.

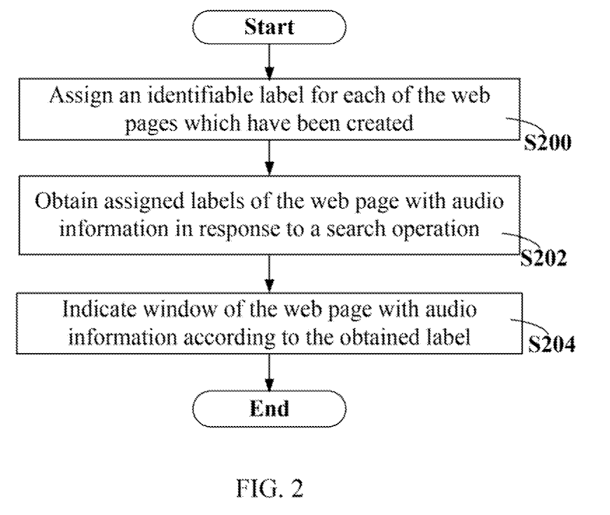

FIG. 2 is a flowchart implementing the web page searching system in a first embodiment of the present disclosure. In step S200, the processing unit 12 assigns an identifiable label for each of the web pages which have been created. The assigned labels are alphanumeric letters that could be identified from each other. The labels could be used to identify the different web pages. For example, if there are 5 web pages created, the processing unit 12 assigns new created numbers of 1 to 5 as labels to these 5 web pages according to a creating order of the web pages.

In step S202, the processing unit 12 obtains the labels of the web pages with audio information in response to a search operation for the web pages with audio information. Typically, the processing unit 12 determines whether the web pages which have been created include audio files one by one, namely the processing unit 12 determines whether the web pages which have been created include the files with the extension name, such as, WAV, MP3, and the like. If the web pages include the audio files, the processing unit 12 obtains the labels of the web pages.

In step S204, the processing unit 12 indicates the window of the web page with audio information according to the obtained labels in the noticeable manner. For example, the processing unit 12 highlights the bar of the window of the web page, so as to distinguish the bar of the window of the web page with the audio information from other windows of the web pages.

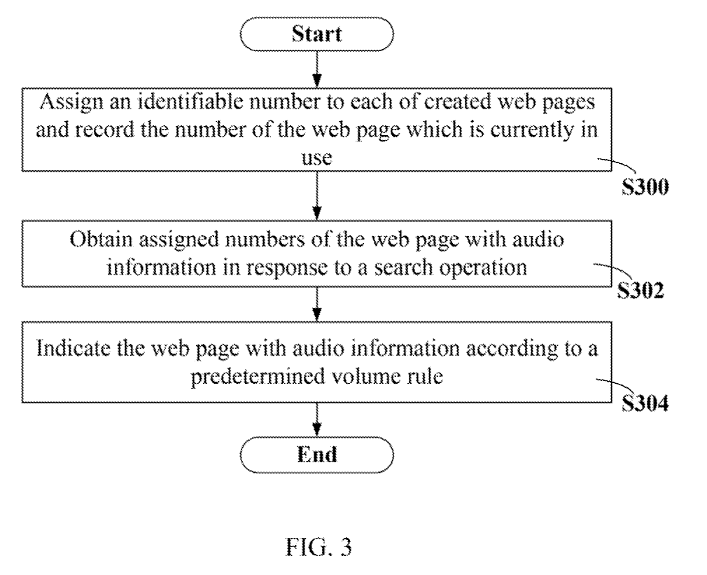

FIG. 3 is a flowchart implementing the web page searching system in a second embodiment of the present disclosure. In the following disclosure, numbers are used as labels to make the present disclosure easy to understand, they also can be letters or other symbols.

In step S300, the processing unit 12 assigns an identifiable number to each of the created web pages, typically, the processing unit 12 assigns the number to each of the created web pages in an order corresponding to the creating order of the web pages. For example, if there are 10 web pages that are created, the processing unit 12 assigns the number of 1 to 10 to the corresponding 10 web pages. The processing unit 12 further records the number of the web page which is currently in use.

In step S302, the processing unit 12 obtains the assigned numbers of the web pages with audio information in response to the search operation for the web pages with audio information.

In step S304, the processing unit 12 indicates the web page with audio information according to a predetermined volume rule. The predetermined volume rule includes a first predetermined volume rule and a second predetermined volume rule.

The first predetermined volume rule is: setting the web page which is currently in use as a center, assigning different output volumes to the left channel and the right channel of the speaker 13 according to the relative position between the bar of the window of the web page with the audio information and the bar of the window of the web page currently in use. When the bar of the window of the web page with audio information is on the left of the bar of the window of the web page currently in use, the output volume of the left channel is greater than the output volume of the right channel; when the bar of the window of the web page with audio information is on the right of the bar of the window of the web page currently in use, the output volume of the right channel is greater than the output volume of the left channel. The relative position between the bar of the window of the web page with the audio information and the bar of the window of the web page currently in use may be determined by the assigned numbers of the web page with audio information and the number of the web page currently in use. For example, supposing the bars of the windows of the created web pages are arranged according to the creating order of the web pages, the created pages are assigned to numbers 1-10 in order, the number of the web page with audio information is 3, and the number of the web page currently in use is 5, then the bar of the window of the web page with audio information is on the left of the bar of the window of the web page currently in use.

The second predetermined volume rule is: assigning different output volume degrees according to the relative distance between the bar of the window of the web page with the audio information and the bar of the window of the web page currently in use. If the bar of the window of the web page with audio information is far away from the bar of the window of the web page currently in use, the output volume will be the lowest degree. For example, supposing there are 7 web pages created, and the fourth web page is currently in use, if the second web page includes audio information, then the assigned volume will be 50%, if the third web page includes audio information, then the assigned volume will be 90%.

During the user searching the website, when the left and right channels of the speaker output unbalanced volume, he can determine the web page with the audio information is located on the left or right of the bar of the window of the web page currently in use. When the user finds the output volume degree is a little lower than normal, he can determine that the bar of the window of the web page with audio information is near the bar of the window of the web page currently in use.

The predetermined volume rule can be predetermined in form of formula shown below:

| | | L | R |
|---|---|---|---|
| K < (N + 1)/2 | X < K | (100%/(N − K + 1)) * (N − 2 * K + X + 1) | (100%/(N − K + 1)) * (N − 2 * K + X + 1) * D |
| | X = K | 100% | 100% |
| | X > K | (100%/(N − K + 1)) * (N + 1 − X) * D | (100%/(N − K + 1)) * (N + 1 − X) |
| K >= (N + 1)/2 | X < K | (100%/K) * (2 * K × X) | (100%/K) * (2 * K × X) * D |
| | X = K | 100% | 100% |
| | X > K | (100%/K) * X * D | (100%/K) * X |

Therein, N is the number of created web pages, K is the assigned number (label) of the web page in use, X is the assigned number (label) of the web page with audio information, D is a factor between 0 and 1, for example, 0.75, L is the left channel, R is the right channel. D is used to achieve the unbalance of volume between the left and the right channel.

As shown in the above table, if K<(N+1)/2 and X<K, the volume of the right channel (R) was multiplied by D, that is, the output volume of the right channel (R) is less than the output volume of the left channel (L); if K<(N+1)/2 and X=K, the output volume of the right channel (R) is equal to the output volume of the left channel (L); if K<(N+1)/2 and X>K, the volume of the left channel (L) is multiplied by D, the output volume of the right channel (R) is larger than the output volume of the left channel (L).

The processing unit 12 could also calculate values and generate a value table according to the first predetermined volume rule and the second predetermined volume rule above. For example, when N is equal to 10, the table is shown below. The processing unit 12 looks up values in the value table according to the assigned number of the created web pages X and the assigned number of the in use web page K. The speaker outputs the audio information according to the values looked up in the value table.

| | K | | | | | | | | | | | | | | | | | | | |
|---|---|---|---|---|---|---|---|---|---|---|---|---|---|---|---|---|---|---|---|---|
| | 1 | | 2 | | 3 | | 4 | | 5 | | 6 | | 7 | | 8 | | 9 | | 10 | |
| X | L | R | L | R | L | R | L | R | L | R | L | R | L | R | L | R | L | R | L | R |
| 1 | 100% | 100% | 89% | 67% | 75% | 56% | 57% | 43% | 33% | 25% | 17% | 13% | 14% | 11% | 13% | 9% | 11% | 8% | 10% | 8% |
| 2 | 68% | 90% | 100% | 100% | 88% | 66% | 71% | 54% | 50% | 38% | 33% | 25% | 29% | 21% | 25% | 19% | 22% | 17% | 20% | 15% |
| 3 | 60% | 80% | 67% | 89% | 100% | 100% | 86% | 64% | 67% | 50% | 50% | 38% | 43% | 32% | 38% | 28% | 33% | 25% | 30% | 23% |
| 4 | 53% | 70% | 58% | 78% | 66% | 88% | 100% | 100% | 83% | 63% | 67% | 50% | 57% | 43% | 50% | 38% | 44% | 33% | 40% | 30% |
| 5 | 45% | 60% | 50% | 67% | 56% | 75% | 64% | 86% | 100% | 100% | 83% | 63% | 71% | 54% | 63% | 47% | 56% | 42% | 50% | 38% |
| 6 | 38% | 50% | 42% | 56% | 47% | 63% | 54% | 71% | 63% | 83% | 100% | 100% | 86% | 64% | 75% | 56% | 67% | 50% | 60% | 45% |
| 7 | 30% | 40% | 33% | 44% | 38% | 50% | 43% | 57% | 50% | 67% | 63% | 83% | 100% | 100% | 88% | 66% | 78% | 58% | 70% | 53% |
| 8 | 23% | 30% | 25% | 33% | 28% | 38% | 32% | 43% | 38% | 50% | 50% | 67% | 64% | 86% | 100% | 100% | 89% | 67% | 80% | 60% |
| 9 | 15% | 20% | 17% | 22% | 19% | 25% | 21% | 29% | 25% | 33% | 38% | 50% | 54% | 71% | 66% | 88% | 100% | 100% | 90% | 68% |
| 10 | 8% | 10% | 8% | 11% | 9% | 13% | 11% | 14% | 13% | 17% | 25% | 33% | 43% | 57% | 56% | 75% | 67% | 89% | 100% | 100% |

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A web page searching method for searching web page with audio information, the method comprising:
assigning an identifiable label for each of created web pages;
obtaining the label of the web page with audio information in response to a search operation; and
indicating the web page to a user corresponding to the obtained label.

2. The web page searching method according to claim 1, wherein the indicating step further includes highlighting bar of window of the web page with audio information.

3. The web page searching method according to claim 1, wherein the indicating step further includes controlling outputting volume to identify the web page with audio information.

4. The web page searching method according to claim 3, wherein the labels are assigned corresponding to an order in creating the created web pages.

5. The web page searching method according to claim 4, wherein the method further includes recording labels of the created web pages and indicating the web page with audio information according to a predetermined volume rule by outputting unbalanced volumes and different volume degrees to a left channel and a right channel of an electronic device.

6. The web page searching method according to claim 5, wherein the predetermined volume rule includes a first predetermined volume rule and a second predetermined volume rule, the first predetermined volume rule is: setting the web page which is currently in use as a center, assigning different output volumes to the left channel and the right channel of the electronic device according to a relative position between bar of window of web page with the audio information and bar of window of the web page currently in use, and the second predetermined volume rule is: assigning different output volume degrees according to a relative distance between the bar of the window of the web page with the audio information and the bar of the window of the web page currently in use.

7. An electronic device used for searching web page with audio information, the electronic device comprising:
a memory for storing a form of program codes, when the electronic device is activated, the program codes are executed to perform the following steps by a processing unit of the electronic device:
assigning an identifiable label for each of created web pages;
obtaining the label of the web page with audio information in response to a search operation; and
indicating the web page to a user corresponding to the obtained label.

8. The electronic device according to claim 7, wherein the indicating step further includes highlighting bar of window of the web page with audio information.

9. The electronic device according to claim 7, wherein the indicating step further includes controlling outputting volume to identify the web page with audio information.

10. The electronic device according to claim 9, wherein the labels are assigned corresponding to an order of creating the created web pages.

11. The electronic device according to claim 10, wherein the method further includes recording labels of the created web pages and indicating the web page with audio information according to a predetermined volume rule by outputting unbalanced volumes and different volume degrees to the left channel and the right channel of the electronic device.

12. The electronic device according to claim 11, wherein the predetermined volume rule includes a first predetermined volume rule and a second predetermined volume rule, the first predetermined volume rule is: setting the web page which is currently in use as a center, assigning different output volumes to the left channel and the right channel of the electronic device according to a relative position between bar of window of the web page with the audio information and bar of window of the web page currently in use, and the second predetermined volume rule is: assigning different output volumes according to a relative distance between the bar of the window of the web page with the audio information to the bar of the window of the web page currently in use.

13. The electronic device according to claim 7, wherein the assigned labels are alphanumeric letters that could be identified from each other.
